(19) United States
(12) Patent Application Publication
(10) Pub. No.: US 2021/0346226 A1
(43) Pub. Date: Nov. 11, 2021

(54) Exercise Device

(71) Applicant: Justin S. Harris, Chicago, IL (US)

(72) Inventor: Justin S. Harris, Chicago, IL (US)

(21) Appl. No.: 16/873,568

(22) Filed: May 8, 2020

(51) Int. Cl. A61H 1/02; A45B 9/02; A45B 9/04; A63B 23/02

(52) U.S. Cl. CPC A61H 1/0292; A45B 9/02; A45B 9/04; A45B 2009/005; A63B 23/0205; A63B 23/0238; A61H 1/0218

(57) ABSTRACT

An exercise device useful in the alleviation of posture- and age-related ailments, and being beneficial in the re-alignment, flexibility, and strengthening of the spine of the human torso and the body's skeletal structure, said exercise device comprising a walking staff or walking stick, being of appropriate length, and having a top or proximal end and a bottom or distal end, a protective hand-grip disposed upon the top or proximal end of said walking staff or walking stick, a protective tip disposed upon said bottom or distal end of said walking staff or walking stick, and a protective sheath covering, at minimum, the central or middle portion of said walking staff or walking stick, and an exercise method useful in the alleviation of said posture- and age-related ailments, and being beneficial in the re-alignment, flexibility, and strengthening of the spine and core musculature of the human torso and the body's skeletal structure while simultaneously serving to re-calibrate the user's center of gravity, balance and equilibrium, said method comprising the steps of positioning the elongate walking staff exercise device behind the user's neck and across the user's shoulders to lift user's chest upwardly and away from said user's pelvic region, with said user's arms being extended across said exercise device at the inner part of said user's elbows such that said user's shoulders are raised upwardly and pulled backwardly and the user's torso is lifted upwardly, while said user's forearms and hands extend across said exercise device forwardly of said user's body, and walking with said exercise device in said shoulder-mounted, arms-extended position, said walking motion providing an alternating back-and-forth motion to the user's arms, shoulders and spinal column inherent to said walking motion so as to facilitate subtle and gentle corrections to said spinal column, while stretching and strengthening the muscles of the abdominal area of said user's torso, and shortening and strengthening the muscles of the user's lumbar region of the lower back, said method also comprising the steps of performing a series of torso-twisting regimens while using said elongate walking staff or walking stick wherein an increasing amount of torque is exerted upon the spinal column of the human torso in direct proportion to the position of the user's hands along the length of said elongate walking staff or walking stick.

This application is a continuation-in-part of application Ser. No. 16/350,054, filed Sep. 21, 2018.

### FIELD OF THE INVENTION

The present invention relates to an exercise device. More particularly, the present invention relates to an exercise device and exercise method that are useful in the alleviation of posture-related ailments, and that are beneficial in improving the re-alignment and flexibility of the spinal column and skeletal structure of the human body, in strengthening the core musculature of the human torso, and in the re-calibration of the body's center of gravity, equilibrium, and balance.

### BACKGROUND OF THE INVENTION

As human beings age, the muscles of the torso or trunk (the body of a person excluding the head and limbs) lose size, strength, firmness, and vitality, the shoulders tend to become rounded by slumping forwardly and inwardly, the spine (backbone) lengthens and curves forwardly, the chest (the body from the neck to the abdomen) slumps downwardly towards the pelvis (the basin-like cavity in the lower part of the trunk), and the rotation of the vertebrae of the lower back or lumbar region of the spinal column (that part of the human body between the lower five ribs on either side of the body and the hipbones) diminishes during the act of walking.

These changes in muscle tone, posture, and movement, in particular the downward subsidence of the chest cavity toward the pelvis, tend to compress the lungs, heart, spleen, stomach, liver, kidneys, and large and small intestines into closer proximity, thus, causing a decrease in their proper natural functioning, and, further, tend to promote a limited range of motion of the human trunk due to the accompanying shortening or stretching of the muscles of the abdomen (that part of the body between the trunk and the pelvis) and back muscles and ligaments (those bands of tissues serving to connect bones or hold organs in place). Still further, decreased lung capacity cause by such vital organ compression tends to restrict the efficient functioning of the lungs, and reduces the amount of oxygen in the blood and body.

Collectively, these changes in muscle tone, posture, and movement can, over time, lead to a large percentage of the chronic ailments associated with aging (breathing disorders, heart disease, stroke, high blood pressure, diabetes, kidney and bladder problems, urinary tract/prostrate disorders, arthritis, dementia, etc.), since, by definition, chronic ailments are those ailments resulting from long un-corrected, habitual activity or inactivity.

Nerve interference may also occur since the spinal column (backbone), which houses the spinal cord (the long, thin tubular structure made up of nervous tissue that extends from the base of the human brain to the lower part of the backbone) is the basis of posture. Ultimately, bad posture affects bowel function since the forward arching and swaying of the spinal column may cause the intestines to sag, possibly resulting in constipation and other gastric abnormalities. Moreover, nerve interference may also initiate increased discomfort and pain in the form of headaches and pain in the jaw, shoulders, arms, hands, and around the eyes.

Still further, the Chart of the Effects of Spinal Misalignments states: “misalignments of the spinal vertebrae may cause irritation to the nervous system, and may affect the structures and function of all of the organs of the human body.” Even further, Gray's Anatomy, the English language textbook of human anatomy, teaches that the nervous system controls and coordinates all organs and structures of the human body.

Exercise devices proposed in the past to facilitate alleviation of these problems have proven to be of complex design, of limited effectiveness, are difficult to store after usage, and are costly to manufacture. One such past attempt to facilitate a solution to this problem appears in U.S. Pat. No. 7,086,992 B2 to Bowman et al which teaches a posture correction device to aid in correcting the common postural condition of kyphosis-lordoris (forward rounding of the back; swayback wherein the spine of a person curves significantly inward at the lower back, characterized by an abnormally rounded upper back) by aiding in the exercise of the spinal erectors (a group of muscles and tendons which run more or less the length of the spine on the left and on the right, from the sacrum, the bony structure beneath the lower back or lumbar vertebrae and between the hips/glutes, and hips to the base of the skull) to strengthen the erectors to pull the user's spine and torso backward into normal alignment. The device operates by seating the user on a declined seat to provide increased resistance by gravity. The device provides resistance to backward movement of the user's body and resistance to backward rotation of the user's arms. The hands of the user are positioned in supinated, palms-up hand positions to increase the training effect of the backward rotation of the user's arms.

Other prior art references which allude to the exercise device and method of the present invention are: U.S. Pat. No. 1,670,390 to Strom, U.S. Pat. No. 4,121,605 to Schmerl, U.S. Pat. No. 5,267,931 to Faetini, U.S. Pat. No. 5,536,229 to Albergo, U.S. Pat. No. 5,996,602 to Cato,lll, and U.S. Pat. No. 7,261,564 B2 to Sutula, Jr.

None of these patents and/or inventions, however, taken either singularly or in combination, is seen to describe or provide the benefits achievable with the instant invention as described and claimed herein.

### SUMMARY OF THE INVENTION

Accordingly, it is an object of the present invention to provide an exercise device useful in the alleviation of posture and age-related ailments.

It is another object of the present invention to provide an exercise device which may serve as a scaffolding-type support implement useful during the performance of a specific exercise method or exercise regimen designed to aid in the renovation, correction, and enhancement of the user's posture and physical stature.

It is still another object of the present invention to provide an exercise device and method which are beneficial in the re-alignment, flexibility, and strengthening of the spinal column and core musculature of the human torso and the body's skeletal structure.

It is a further object of the present invention to provide an exercise device and method for achieving correct posture through a progressive and steady re-alignment of the spinal vertebrae and inter-vertebral discs of the user's spinal column via a non-rigorous, low-impact exercise regimen.

It is a still further object of the present invention to provide an exercise device and exercise method that are useful in re-adjusting the user's center of gravity, balance, and equilibrium so that the user's body weight may be equally distributed on the user's body frame, over time.

It is yet another object of the present invention to provide a portable exercise device of simplistic design and construction, which is inexpensive to manufacture, and which is easy to store following use.

These and other objects of the present invention will be best understood upon a reading of the following detailed description taken in conjunction with the accompanying drawings which form part of the specification, with the understanding, however, that the invention is not confined to a strict conformity with the drawings but may be changed or modified so long as such changes or modifications constitute no material departure from the salient features of the invention as expressed in the appended claims.

### BRIEF DESCRIPTION OF THE DRAWINGS

FIG. 1 is a perspective view of the exercise device of the present invention.

FIG. 2 is a perspective view of an orthopedically-contoured cervical support padding means which forms part of n embodiment of the exercise device of the present invention.

FIG. 3 is a perspective view of the exercise device of the present invention illustrating two (2) protective coverings spaced apart equidistance from the center of the elongate staff forming part of the present invention.

FIG. 4 is an illustration of the exercise device of the present invention with the elongate staff of said exercise device exhibiting a curved configuration formed into the central portion thereof.

FIG. 5 is an illustration of the exercise device of the present invention with the elongate staff of said exercise device exhibiting a curved configuration formed into the central portion thereof with protective sheath covering.

FIG. 6 is a perspective view of the present invention demonstrated in accordance with the walking regimen forming part of the exercise method of the present invention.

FIGS. 7-11 depict perspective views of the exercise device of the present invention being demonstrated in accordance with the torso-twisting/torso-bending regimen forming part of the exercise method of the present invention.

FIG. 12 is a perspective view of the present invention being utilized as a support means while performing a squatting exercise regimen for strengthening the muscles and joints of the lower human skeleton.

FIG. 13 is a perspective view of the present invention demonstrating the walking regimen forming part of the exercise method hereof being performed on a treadmill or the like, the elongate staff of said exercise device also being capable of being adapted for appropriate overhead attachment to a wall, ceiling cable, suspension pole, or the like, and/or being capable of being operatively and securely connected to the base or support structure of the treadmill.

FIG. 14 illustrates the utilization of elongate exercise device of the present invention being used in combination with the performance of exercises, or a workout, on a stationary bicycle, exercise bike, spinning bike, exer-cycle, or the like.

### DESCRIPTION OF THE PREFERRED EMBODIMENTS

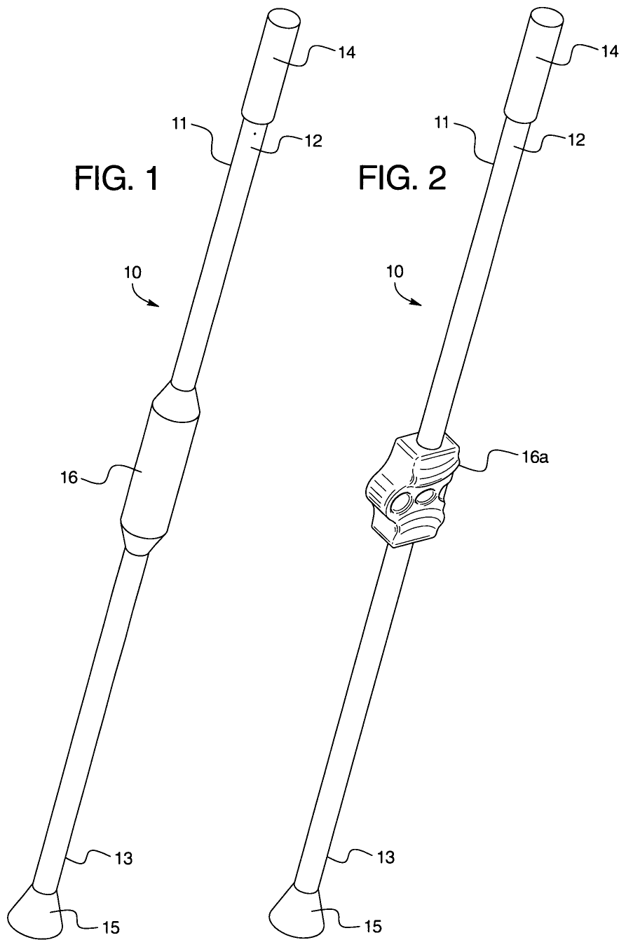

Referring now to the drawing figures, FIG. 1 depicts the exercise device 10 of the present invention illustrated as an elongate walking staff 11 having a proximal end 12 and a distal end 13. Proximal end 12 may include a protective hand-grip means 14 disposed thereupon, while distal end 13 may terminate in the provision of a protective tip means 15. Centrally-disposed upon elongate walking staff 11 may be a protective sheath covering means 16 for covering the circumference of the central or middle portion of the walking staff 11.

Walking staff 11 of exercise device 10 may be constructed of any appropriate metal, plastic, wood, or carbon fiber material, and may be of any appropriate length, but preferably of a length between three and six feet, generally depending on the height and/or arm span of the user. Walking staff 11 may be constructed as a single, elongate, solid or tubular structure, or may, alternatively, be constructed of several shorter or retractable components which may be appropriately interconnected or expanded to provide the elongate walking staff 11 of the present invention.

FIG. 2 depicts a perspective view of the elongate walking staff 11 of the exercise device 10 of the present invention fitted, alternatively, with an orthopedically-contoured, cervical spine protection means 16a disposed upon the central or middle portion of the walking staff 11.

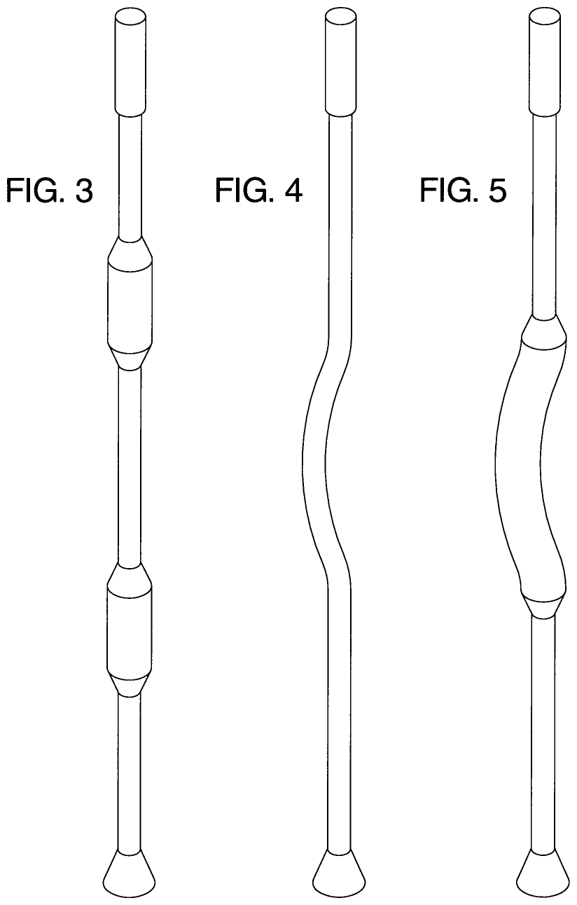

As can be seen in FIG. 3, another embodiment of the invention may include elongate walking staff 11 having two protective sheath coverings 16, 16b spaced apart from the center thereof such that coverings 16, 16b will rest upon the shoulders of the user to provide a space on the elongate staff 11 behind the user's cervical spine which does not rest upon that area of the neck and shoulders of the user during walking or the performance of the exercise regimen.

Yet another embodiment of the invention may contemplate the curvature of walking staff 11 in the middle thereof such that it curves around the back of the neck or of the user's cervical spine in such a manner that walking staff 11 rests upon the shoulders of the user. This adaptation may or may not include the provision of a protective sheath covering 16c which covers the curvature designed into walking staff 11 as well as a portion of its length as illustrated in FIGS. 4 and 5.

In like manner, hand-grip means 14 disposed upon proximal end 12 of walking staff 11 may be constructed of any suitable material such as rubber, plastic, foamed plastic, composite, leather, or a durable cloth material.

Protective tip 15, which is disposed upon the distal end 13 of elongate walking staff 11, is preferable constructed of a steel-reinforced Neoprene rubber, or any other suitable, slip-resistant, durable material capable of withstanding the rigors of a walking regimen wherein the tip 15 contacts hard, rough walking surfaces such as concrete, blacktop, and wood, or grassy, sandy, or hilly earthen surfaces as may be encountered on nature walks and hikes.

Protective sheath covering 16 may be constructed of any suitable material so long as it is appropriate for the intended purpose of providing sufficient cushioning against irritation of the user's cervical spine and the user's skin and muscles surrounding the cervical spinal region of the upper back and shoulders.

Protective sheath covering 16 may be of varying thickness, and may be constructed of such length that it covers only the central or middle portion of elongate walking staff 11 of exercise device 10. Alternatively, protective sheath covering 16 may be constructed such that it covers up to as much as the entire length of elongate walking staff 11 between protective hand-grip 14 and protective tip 15, or any desired portion thereof.

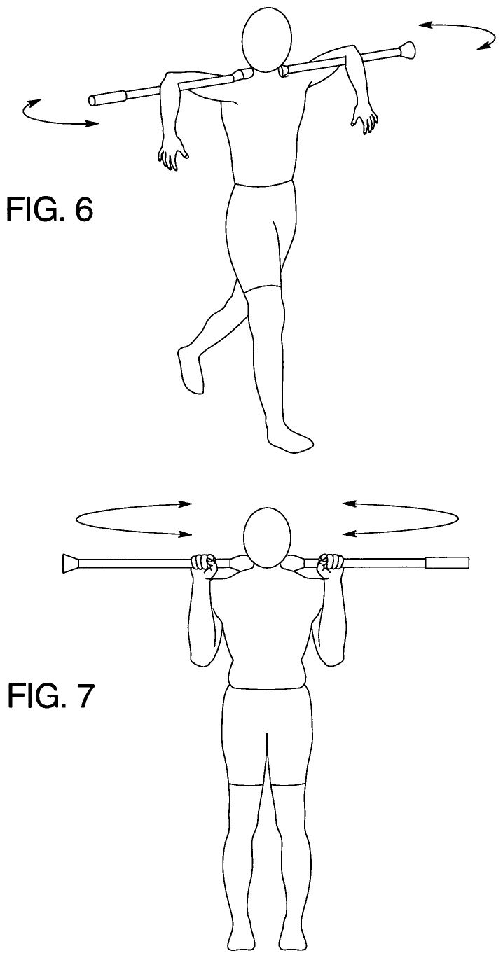

As can be seen, FIG. 6 illustrates the use of the elongate walking staff 11 of exercise device 10 of the present invention being deployed in the exercise method hereof as a scaffold-type implement being held in a horizontal position behind the user's neck and across the user's shoulders to serve as a temporary structure or scaffolding for holding the user body in an erect position during the intended exercise-induced repair or renovation of the user's skeletal structure and core musculature. With the user's arms being extended across exercise device 10 at the inner part of the user's elbows, the user's torso is lifted upwardly or raised, while the user's forearms and hands extend across the exercise device 10 forwardly of the user's body. Walking with the exercise device 10 of the present invention in this position, along with the natural momentum, or the oscillating back and forth swaying motion inherent in the walking stride, facilitates subtle and gentle corrections to the spinal column and skeletal structure, while simultaneously strengthening the abdominal, lower lumbar, and core muscles of the human torso.

Therefore, a proper strengthening of the soft tissue muscles of the human trunk (core muscles) through mechanical action to ensure adequate muscle tone and development, and a re-alignment of the vertebrae and interconnecting discs of the spinal column to correct the bad posture resulting from the loss of core musculature strength of the human trunk, will facilitate the elimination of many of the structural and chronic ailments associated with aging.

Accordingly, substantial progress in the reduction and/or elimination of posture and age-related ailments can be realized via the use of this simple, scaffolding support-type exercise implement or device 10 which may be utilized in the performance of a specific, dynamic, non-rigorous, low-impact exercise regimen or method which is readily-available to all, irrespective of body type, sex, or age.

Dictionary.com defines the science of “dynamics” as that branch of mechanics that deals with the motion and equilibrium of the body under the action of forces, usually from outside the body. Further, “mechanics” is defined as that branch of physics that deals with the action of forces on the body with motion. Still further, “exercise” is defined as a regulated course of movements intended to preserve or restore health or attain some result due to the action of forces on the body with motion.

An elongate walking staff 11 is utilized in performing the exercise method of the present invention, and is deployed horizontally behind the user's neck and across the user's shoulders to lift the user's torso and relieve pressure from the vertebrae and interconnecting discs of the spinal column while providing a fulcrum, central pivot, or equilibrium point from which side-to-side horizontal oscillations of the elongate staff and user's torso may be initiated in order to:

(1) facilitate an optimum performance of the exercise regimen, (2) maximize the physical and therapeutic benefits derived from performing the exercise regimen, and (3) serve as a temporary structure or support scaffolding for holding the user's body in an erect position during the intended exercise-induced renovation or restoration of the user's core musculature and skeletal structure.

With the user's arms being extended across the elongate device 11 at the inner part of the user's elbows to pull and hold the shoulders backwardly, the user's torso or trunk is simultaneously lifted or raised, while the user's forearms and hands extend across the device 10 forwardly of the user's body. Walking with the device 10 in this position, along with the natural oscillating, or swaying, motion inherent in the walking stride, facilitates subtle and gentle corrections to the spinal column and skeletal structure, while simultaneously strengthening the abdominal, lower lumbar, and core muscles of the human torso.

Typically, in this horizontally-disposed, shoulder-placed, inner elbow-held walking position, the user's chest is lifted upwardly and away from the user's pelvic region, and serves to optimize the performance of the exercise regimen by:

(1) pulling the shoulders backwardly into a more erect carriage, so as place the user's body in a proper bearing to begin initiation of a re-setting of the user's center of gravity (the mechanical focus of the body's stability), balance (the equal distribution of the body's weight across the body's skeleton, and equilibrium (that state of balance due to the equal action of opposing forces),

(2) stretching and lengthening the muscles of the abdominal area of the user's torso,

(3) lengthening and increasing the flexibility of the spinal column,

(4) straightening and re-aligning the position of the inter-vertebral discs of the user's spinal column, and

(5) shortening and strengthening the muscles of the lumbar region of the lower back.

For example, in the 20-25 minutes it would take to walk a mile (5,280 feet) at a slow to moderate pace while practicing the exercising method and using the elongate exercise device 10, the user having a walking stride measuring 3 feet in length would perform 1,760 walking steps, or 880 side-to-side repetitions (back and forth oscillations of the upper torso) during that mile walk. The number of such side-to-side repetitions will provide a more-than-adequate measure of dynamic actions of gentle force on the swaying and oscillating body of the user to begin to provide an almost immediate increase in spinal column flexibility and strengthening of the user's core musculature, accompanied by the gentle re-alignment of the discs of the spinal column, a correcting re-calibration of the user's center of gravity, and a noticeable enhancement of the user's balance and equilibrium, so as to begin to facilitate improved posture while serving to prevent the occurrence of back or neck pain and discomfort or the like.

In gradually re-adjusting the user's center of gravity, balance, and equilibrium, the skeleton (the bones of the human body considered as a whole, together forming the internal framework of the body), in like manner, undergoes something of a structural rehabilitation or recovery. Any un-equal distribution of the body's weight which tends to exert unwanted excessive pressure on the vital parts of the skeleton, e.g. the hip joints, the knees, and the ankles, etc., is gradually brought back into proper functional alignment, and the user's body weight is, once again, equally distributed on the user's body frame or skeleton. This structural recovery provides additional benefits in the guise of the elimination or reduction of pain and discomfort in the neck, shoulders, hips, knees, ankles, feet, and toes.

Improper body alignment limits function, and, thus, is of concern, irrespective of occupation, activities, environment, body type, sex, or age. Bad posture can be effectively overcome by applying certain specific mechanical principles, since postural alignment can be voluntarily controlled to a significant extent by spinal column discs adjustments and upper body exercises.

Spinal misalignments are reflected in bad posture, and can possibly be caused by gravitational forces. While gravity stabilizes the lower extremities of the body in standing, and provides friction for locomotion, it also places considerable stress on those body parts responsible for maintaining the upright position or correct posture. As gravity acts on all body parts, one's entire weight can be considered as being concentrated at the point where the gravitational pull on one side of the body is equal to the pull on the other side. This point is the body's center of gravity, and it constitutes the exact center of body mass.

Moreover, the accumulation of fat and the loss of soft tissue tone are common factors in altering one's center of gravity. Therefore, the center of gravity shifts with each change in body alignment, and the amount of weight borne by the joints of the body and the pull of the muscles vary within reasonable limits with each body movement.

There are also therapeutic improvements realized from the re-alignment of the vertebrae and inter-vertebral discs of the spinal column. The central nervous system (the brain and the spinal cord) is so named because it integrates information it receives from all parts of the body, and then coordinates and influences the activities of all these body parts, as per the teachings of both The Chart of the Effects of Spinal Misalignments and Gray's Anatomy.

The brain is encased in the skull, and is protected by the cranium. The spinal cord is contiguous with the brain, lies near the tail or posterior end of the brain, and is protected by the vertebrae of the spinal column. Spinal cord nerves connect the spinal cord to skin, joints, muscles, etc., and transmit motor and sensory signals and stimuli. This allows for voluntary and involuntary motions of the muscles, as well as the perceptions of the senses.

The brain makes up the largest portion of the central nervous system, and is its major functional unit. While the spinal cord has certain processing abilities, such as that of spinal locomotion and can process reflexes, the brain is the major processing unit of the nervous system.

There are many central nervous system diseases and conditions, including infections of the central nervous system such as late-onset neurodegenerative diseases like dementia and Alzheimer's disease, and it is quite probable that the un-constrained movement of electrical impulses and cerebrospinal fluid (CSF) through the central nervous system will significantly decrease the biomarkers associated with system malfunction and inefficiency, and could lead to an enhanced functioning of our central nervous system.

Cerebrospinal fluid bathes and protects the central nervous system. It is made by blood vessels in the brain, and flows down the middle of the spinal cord through a central canal. To prevent waste products such as carbon dioxide from building up in the cerebrospinal fluid, the brain makes new CSF about four times a day. The old CSF drains out into the bloodstream, bringing waste products with it. The bloodstream can then carry these waste products out into the blood, which, in turn, can carry them to the organs that can get rid of them. For example, the bloodstream carries carbon dioxide to the lungs, where it can be breathed out.

Cerebrospinal fluid (CSF) is created from blood plasma, and is 99% water. It carries protein, glucose (sugar), nutrients, neurotransmitters, and electrolytes (salts) like sodium, potassium, calcium, magnesium, and chloride. There are very few white blood cells in the CSF, and no red blood cells at all.

It is certainly very reasonable to conclude that the central nervous system will function more efficiently and effectively without the unwanted build-up of plaque and the like on the walls of the central canal which runs down the middle of the spinal cord to and from the brain, especially if that build-up is facilitated by any deviation of the flow path caused by misaligned spinal column vertebrae and/or inter-vertebral discs.

It is possible that re-invigorating the central nervous system may play a central role in preventing the build-up of amyloid plaque on the brain, and, thus, aid in the prevention of Alzheimer's disease and other degenerative cognitive abnormalities.

The re-alignment of spinal column vertebrae and discs may serve to eliminate the causes irritating the central nervous system. Inasmuch as this re-alignment, or re-set, initiates the more efficient functioning of the organs of the body of the user, leading to the healthier functioning of the body's organs.

Therefore, coupled with strengthened core musculature, the lengthening, stretching, and toning of the user's abdominal area, and the re-calibration of the user's center of gravity, equilibrium, and balance, the user's health should improve appreciably, thus, indicating the real possibility of increased longevity or longer life, not to mention decreasing the need for the use of body braces and body appliances, harsh and expensive medication regimens, and/or life-altering surgical procedures in order to attempt alleviation of posture-related ailments and the pain associated therewith.

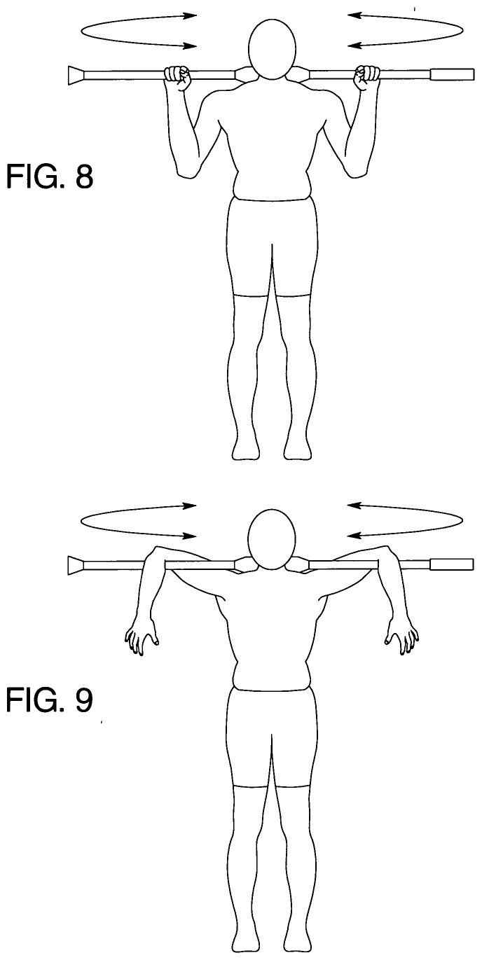

As can be seen in FIG. 7, in order to further facilitate the realization of a more correct posture and enhanced re-alignment of the user's spinal column, a torso-twisting exercise regimen is contemplated through the utilization of exercise device 10 while the user is standing still. In such standing position, exercise device 10 is placed horizontally across the user's shoulders. The shoulder-positioned exercise device 10 will then be grasped by the user at a shoulders-width position along the length of elongate walking staff 11. Hand placement in the shoulders-width position will permit the safe performance of a horizontal twisting motion while asserting but a minimum amount of torque through such horizontal twisting motion on the user's spinal column. This horizontal torso-twisting tends to aid in the re-alignment, flexibility, and strengthening of the spinal column.

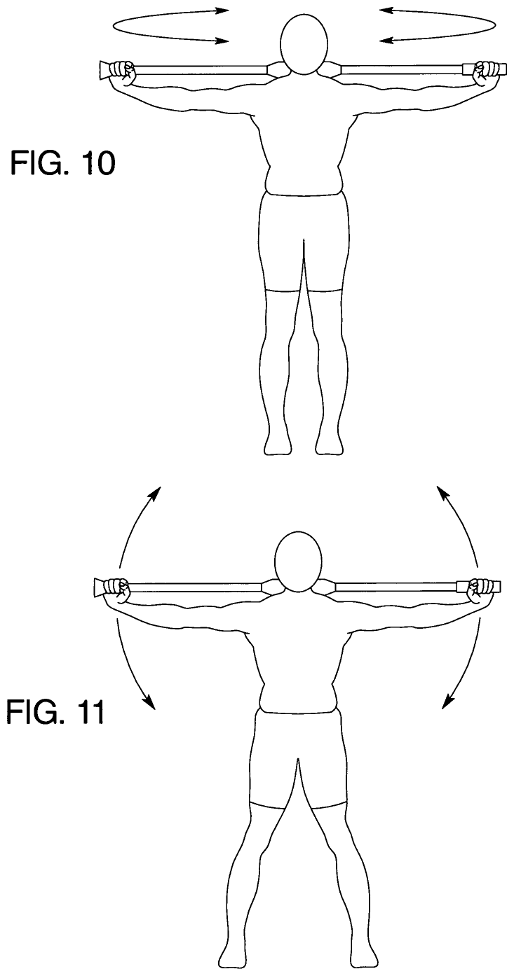

The spinal torque realized in the torso-twisting exercise regimen depicted in FIG. 7 is further intensified by the movement of the hands several inches outwardly along the length of elongate walking staff 11, as is depicted in FIG. 8.

In like manner, more intensity is realized in the stationary or standing-still torso-twisting exercise regimen, with a concomitant lifting of the chest upwardly and away from the pelvis, when, as illustrated in FIG. 9, the user performs the torso-twisting exercise regimen with the elbows placed over the elongate walking staff 11 with hands suspended, as previously depicted in FIG. 6.

Maximum horizontal torso-twisting is realized through utilization of the elongate walking staff 11 of the exercise device 10 of the present invention when the hands and arms are extended along the length of elongate walking staff 11, such that one hand grasps the protective hand-grip 14 disposed upon the proximal end 12, and the other hand grasps the protective tip 15 disposed upon the distal end 13 of the elongate walking staff 11 as depicted in FIG. 10.

Further spinal flexibility, re-alignment, and strengthening may be realized through the performance of a vertical torso-twisting or torso-bending regimen, as is illustrated in FIG. 11.

Such vertical torso-twisting, torso-bending regimen may be performed and further enhanced by the suspension of the hands and forearms along the length of and over the elongate walking staff 11 as previously illustrated in FIGS. 6 through 9.

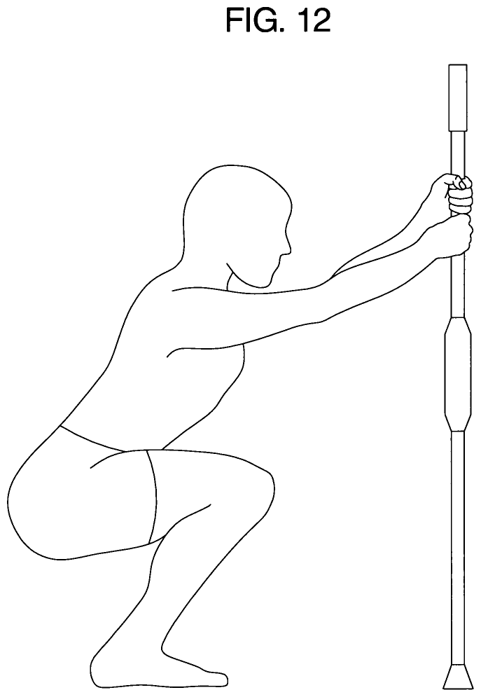

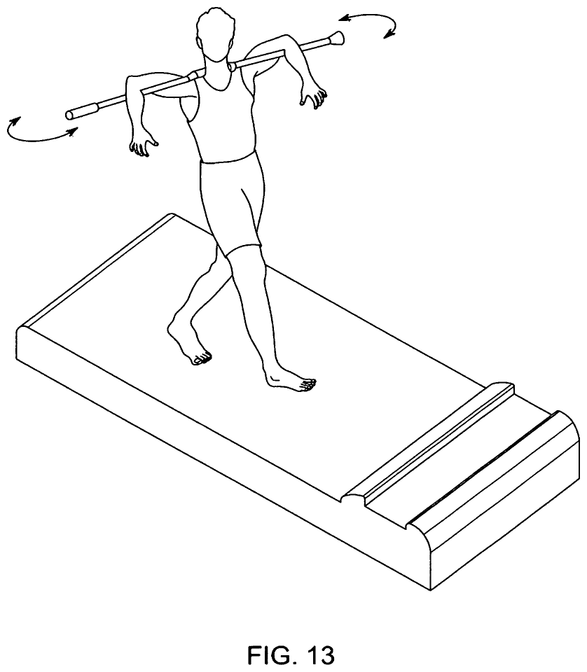

Elongate walking staff 11 may also be utilized in the performance of squatting exercises as is illustrated in FIG. 12. As can be seen, elongate walking staff 11 is positioned essentially perpendicular to the ground while resting on protective tip 15 disposed upon its distal end 13. Squats may be performed while placing the hands upon or near the protedive hand-grip 14 disposed upon the proximal end 12 of elongate walking staff 11 so as to provide a user support means while performing the squatting exercises. The grasping of the elongate walking staff 11 at or near the location of protective hand-grip 14 also provides for the additional stretching of the arms, shoulders, upper torso, and lower back, as can readily be seen as illustrated.

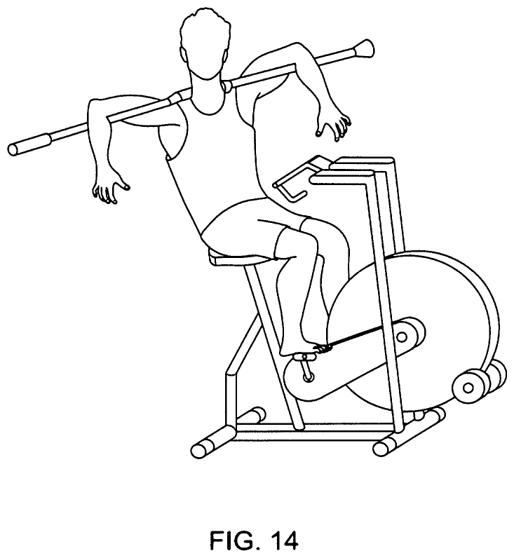

Still further, FIG. 13 illustrates a perspective view of the present invention demonstrating the walking regimen forming part of the exercise method hereof being performed on a treadmill 20. Elongate staff 11 of said exercise device 10 may be deployed for appropriate overhead attachment to a cable, a wall, or a suspension pole or the like which may be adapted for secure attachment to the base of treadmill 20.

As illustrated in FIG. 14, the elongate exercise device 11 of the present invention being used in combination with the performance of exercises, or a workout, on a stationary bicycle, exercise bike, spinning bike, exer-cycle, or the like. Inasmuch as exercising on a stationary bike normally targets the toning of the legs, thighs, buttock, abdominal muscles, and back muscles, the optionaluse of the elongate staff 11 as provided hereinabove, while obviating the standard use of the arms and hands upon the handlebars in the forward-leaning position, contemplates the user sitting upright on the seat with the arms being extended across he elongate device or staff 11 at the inner part of the user's elbows in order to pull and hold the elbows and shoulders backwardly. The accompanying natural oscillating or swaying motion of the user's upper torso or trunk during the alternating leg and/or foot action of pedaling will inherently facilitate subtle and gentle corrections to the spinal column, while simultaneously strengthening the abdominal, lower back, and core muscles of the human torso.

While the performance of the disclosed exercise method has hereinabove been described as preferably being performed with elongate exercise staff 11 being placed behind the user's neck and across user's shoulders so as to provide a fulcrum, central pivot, or equilibrium point from which side-to-side horizontal and/or vertical oscillations of the elongate staff 11 may be initiated in order to facilitate optimal performance of the exercise regimen, it should be noted that the present invention also contemplates that the stabilized, treadmill-adapted performance of the exercise regimen may be executed with the user's arms being more fully extended overhead, since such adaptation envisions a lifting of elongate staff 11 from the user's neck and shoulders so as to facilitate a more complete raising of the user's torso or trunk in order to achieve the stated aims or results contemplated in the performance of the exercise regimen.

From the foregoing it will be seen that this invention is one well adapted to attain all of the ends and objects hereinabove set forth, together with other advantages which are obvious and inherent to the exercise device and exercise method.

As many possible embodiments may be made of the invention without departing from the scope thereof, it is to be understood that all matters herein set forth or shown in the accompanying drawings are to be interpreted as illustrative and not in a limiting sense. While certain particular embodiments of the present invention have been herein illustrated and described, they are not intended to limit the invention to such disclosures, but changes and modifications may be made therein and thereto.

It is also to be understood that the phraseology and terminology herein employed are for purposes of description and not of limitation since the scope of the present invention is denoted by the appended claims.

What is claimed is:

1. An exercise device useful in the alleviation of posture- and age-related ailments, and being beneficial in the re-alignment, flexibility, and strengthening of the spinal column and inter-vertebral discs of the human torso and the body's skeletal structure, said exercise device comprising
(a) a walking staff or walking stick, being of appropriate length, and having a top or proximal end and a bottom or distal end,
(b) a protective hand-grip disposed upon the top or proximal end of said walking staff or walking stick,
(c) a protective tip disposed upon said bottom or distal end of said walking staff or walking stick, and
(d) a protective sheath covering, at minimum, the central or middle portion of said walking staff or walking stick.

2. The exercise device of claim 1, wherein said walking staff or walking stick is preferably constructed of metal, plastic, wood, or appropriate composite material.

3. The exercise device of claim 1, wherein said walking staff or walking stick is preferably between 3 feet and 6 feet in length.

4. The exercise device of claim 1, wherein said protective hand grip is preferably made of a rubber, foamed rubber, plastic, foamed plastic, composite, leather or durable cloth material.

5. The exercise device of claim 1, wherein said protective tip is preferably made of a rubber, foamed rubber, plastic, foamed plastic, leather, or durable cloth material.

6. The exercise device of claim 1, wherein said protective tip is preferably constructed of a steel-reinforced Neoprene rubber.

7. The exercise device of claim 1, wherein said elongate walking staff may be constructed of several shorter components which are appropriately interconnected to provide the elongate walking staff.

8. The exercise device of claim 1, wherein said protective sheath covering may, alternatively, be constructed such that it covers up to as much as the entire length of said elongate walking staff between said protective hand-grip and said protective tip, or any desired portion thereof.

9. The exercise device of claim 1, wherein said protective sheath covering may be constructed of any suitable material which provides sufficient cushioning against irritation of the user's cervical spine and the user's skin and muscles surrounding the cervical spinal region of the upper back and shoulders.

10. An exercise device useful in the alleviation of posture- and/or age-related ailments, and being beneficial in the re-alignment, flexibility, and strengthening of the spinal column and inter-vertebral discs of the human torso and the body's skeletal structure, said exercise device comprising
(a) a walking staff or walking stick, being of appropriate length, and having a top or proximal end and a bottom or distal end,
(b) a protective hand-grip disposed upon the top or proximal end of said walking staff or walking stick,
(c) a protective tip disposed upon said bottom or distal end of said walking staff or walking stick, and
(d) protective sheath coverings spaced apart from the center of said walking staff along the length thereof for resting upon the user's shoulders, the space between said protective sheath coverings providing an area along said length of said walking staff behind the user's cervical spine which does not rest upon that area of the neck and shoulders and/or upon which the user's inner elbows may dwell during the performance of exercises with said exercise device.

11. An exercise device useful in the alleviation of posture- and/or age-related ailments, and being beneficial in the re-alignment, flexibility, and strengthening of the spinal column of the human torso and the body's skeletal structure, said exercise device comprising
(a) a walking staff or walking stick, being of appropriate length, and having a top or proximal end and a bottom or distal end, the middle portion of said walking staff being conformed so as to curve around back of the user's cervical spine in such a manner that the remainder walking staff rests upon the shoulders of the user during the performance of exercises with said exercise device,
(b) a protective hand-grip disposed upon the top or proximal end of said walking staff or walking stick,
(c) a protective tip disposed upon said bottom or distal end of said walking staff or walking stick, and
(d) a protective sheath covering, at minimum, the central or middle portion of said walking staff or walking stick.

12. An exercise device useful in the alleviation of posture- and/or age-related ailments, and being beneficial in the re-alignment, flexibility, and strengthening of the spinal column of the human torso, and the body's skeletal structure and core musculature, said exercise device comprising
(a) a treadmill , and
(b) an elongate staff or the like being deployed for appropriate overhead attachment to a suspension pole, ceiling cable, or the like.

13. An exercise method useful in the alleviation of posture- and age-related ailments, and being beneficial in the re-alignment, flexibility, and strengthening of the spinal column, intervertebral discs, and core musculature of the human torso and the body's skeletal structure while simultaneously serving to re-calibrate the user's center of gravity, balance and equilibrium, said method comprising the steps of
(a) positioning the elongate walking staff exercise device of claim 1 behind the user's neck and across the user's shoulders to pull user's chest upwardly and away from said user's pelvic region, with said user's arms being extended across said exercise device at the inner part of said user's elbows such that said user's shoulders are raised upwardly and pulled backwardly and the user's torso is lifted upwardly, while said user's forearms and hands extend across said exercise device forwardly of said user's body, and
(b) walking with said exercise device in said shoulder-mounted, arms-extended position, said walking motion providing an alternating back-and-forth motion to the user's arms, shoulders and spinal column inherent to said walking motion so as to facilitate subtle and gentle corrections to said spinal column, while stretching and strengthening the muscles of the abdominal area of said user's torso, and shortening and strengthening the muscles of the user's lumbar region of the lower back.

14. An exercise method useful in the alleviation of posture- and age-related ailments, and being beneficial in the re-alignment, flexibility, and strengthening of the spine of the human torso and the body's skeletal structure, said method comprising the steps of
(a) positioning the elongate walking staff exercise device of claim 1 behind the user's neck and across the user's shoulders to pull user's chest upwardly and away from said user's pelvic region, with said user's arms extending along the length said exercise device such that said user's shoulders are raised upwardly and pulled backwardly, and
(b) performing a series of torso-twisting exercise regimens while using the elongate staff exercise device of claim 1 wherein an increasing amount of torque is exerted upon the spinal column of the human torso in direct proportion to the position of said user's hands along said length of said elongate walking staff exercise device.

15. The exercise method of claim 12, wherein said torso-twisting exercises include the horizontal positioning of the elongate walking staff exercise device of claim 1 behind the user's neck and across the user's shoulders to pull user's chest upwardly and away from said user's pelvic region, with said user's arms being extended across said exercise device at the inner part of said user's elbows such that said user's shoulders are raised and pulled backwards, while said user's forearms and hands extend across said exercise device forwardly of said user's body.

16. The exercise method of claim 13, wherein said torso-twisting exercises are performed while twisting said elongate walking staff exercise device along a horizontal plane.

17. The exercise method of claim 13, wherein said torso-twisting exercises are performed while twisting said elongate walking staff exercise device along a vertical plane.

18. An exercise method useful in the alleviation of posture- and age-related ailments, and being beneficial in the re-alignment, flexibility, and strengthening of the spine of the human torso, said method comprising the steps of
(a) placing the protective tip disposed upon the bottom or distal end of the walking staff or walking stick of the exercise device of claim 1 upon the ground or exercise surface at arms length directly in front the user,
(b) positioning both of user's hands upon, or in close proximity to, the protective hand-grip disposed upon the top of said walking staff or walking stick so as to grip same, and
(c) performing a squatting exercise regimen while maintaining said arms length position.

19. An exercise device for performing the walking regimen of the exercise method, comprising
(a) a treadmill, and
(b) a treadmill attachment means adaptable for use with said treadmill for providing an overhead suspension, stabilization, and/or attachment means from which said elongate exercise staff may be operatively attached to or suspended from during the performance of said walking regimen of said exercise method.

20. An exercise device for performing the torso-twisting, torso-bending regimen of the exercise method of the present invention, comprising the utilization of elongate device or staff of the present invention being used in combination with the performance of exercises on a stationary bike, exercise bike, spinning bike, exercycle, or the like, said stationary bike targeting the toning of the legs, thighs, buttock, abdominal muscles, and including the optional use of the elongate staff of the present invention, while obviating the standard use of the arms and hands upon the handlebars in the forward-leaning position, said exercise method contemplating the user sitting upright on the seat of said stationary bike with the user's arms being extended across the elongate device or staff at the inner part of the user's elbows in order to pull and hold the user's elbows and shoulders backwardly so as to facilitate the natural oscillating or swaying motion of the user's upper torso or trunk during the alternating leg and/or foot action of pedaling so as to facilitate subtle and gentle corrections to the spinal column, while simultaneously strengthening the abdominal, lower back, and core muscles o9f the human torso.
